(19) United States
(12) Patent Application Publication
(10) Pub. No.: US 2007/0158085 A1
(43) Pub. Date: Jul. 12, 2007

(54) Fire extinguishing apparatus and method with gas generator and extinguishing agent

(75) Inventors: Christophe Bourdet, Roinville sous Dourdan (FR); Gilles Chabanis, Versailles (FR); Philippe Mangon, Elancourt (FR)

Correspondence Address: SIEMENS SCHWEIZ AG;I-47, INTELLECTUAL PROPERTY, ALBISRIEDERSTRASSE 245, ZURICH, CH-8047, CH

(73) Assignee: Siemens S.A.S., Saint-Denis (FR)

(21) Appl. No.: 11/591,905

(22) Filed: Nov. 2, 2006

(30) Foreign Application Priority Data
Nov. 4, 2005 (EP) 05292357.0

(51) Int. Cl. A62C 2/00

(52) U.S. Cl. 169/46; 169/16; 169/85; 169/5

(57) ABSTRACT

A fire extinguishing apparatus and method are proposed, comprising: a container configured to receive and retain a fire extinguishing agent; a pressure generator coupled to the container to have a generated pressure act upon the fire extinguishing agent to expel the fire extinguishing agent over an expel-exit of the container. Due to a separator which is placed within the container so that the fire extinguishing agent and the pressure generator are separated, it is advantageously possible to provide a pressure effect on the extinguishing agent without any risks of mixing a pressurized gas from the pressure generator and the extinguishing agent, especially by the ignition phase of the pressure generator, wherein only the extinguishing agent has to be expelled out of the container. Furthermore some means related to the separator will be proposed for improving the expelling of the extinguishing agent out of container.

### BACKGROUND OF THE INVENTION

The present invention relates to an apparatus and a method for extinguishing a fire. More particularly, the invention relates to a fire extinguishing apparatus and a method using a pressure generator like a gas generator.

A variety of different systems and methods for extinguishing and suppressing a fire are known. These systems are based on different principles using a variety of fire extinguishing agents. For example, water removes energy from a fuel, inert gas displaces oxygen from a fire, dry chemicals separate oxygen from fuel, and Halons (e.g., Halon 1301) breaks the chain reaction of afire by preventing the fuel and oxygen from combining in the presence of heat.

U.S. Pat. No. 5,449,041 describes a fire suppression apparatus, which uses gas as fire suppression agent, for use within a building, aircraft, or other suitable structure or vehicle. The apparatus has a gas generator and a vaporizable liquid contained within a chamber. When activated, the gas generator generates a high-temperature gas, which substantially vaporizes the liquid by interaction with the generated gas. By vaporizing the liquid a gas is generated that has flame extinguishing and suppressing capabilities.

A fire extinguishing system that uses Halon usually retains the Halon in a container and uses nitrogen N₂ to pressurize the Halon, for example, at about 40 bar at room temperature. Upon activation of the fire extinguishing system, a valve opens and the pressurized Halon is expelled from the container. Halons are most efficient fire extinguishing agents, but pose a threat to the environment and are, therefore, only allowed for a few limited applications, for example, in aircrafts.

Since Halon requires laborious means of maintenance (needs pressurization) and should have a restricted use due to its non-ecological property, some new extinguishing agent are tending to be used to solve this problems. One of them is called Novec® (Company 3M) that provides a high quality of fire extinguishing as well as a simple maintenance due to its liquid phase without needs of pressurization. In opposite to Halon, Novec is also not so aggressive against the environment.

In certain fire extinguishing applications, such as in non-enclosed spaces or in spaces with non negligible ventilation (e.g., engine fire protection, power generators, or electronic bays) it is necessary to reach very quickly a threshold concentration of the extinguishing agent to extinguish the fire and then to maintain at least this concentration during a predetermined period of time to prevent the fire from a re-ignition. Such an example is given through the publication US 2005/0150663 A1, in the aforesaid Halon-based system, the Halon reaches the threshold concentration within a first phase of the discharge process. The first phase includes a period of relative slow increase of concentration. Within a second phase, the Halon significantly exceeds the threshold concentration, and within a third phase, the Halon decreases below the threshold concentration until the end of the discharge process. Especially by mean of adapting the properties of the (pyrotechnical based) gas generator as igniter, a fire extinguishing apparatus is provided so that an improved mechanism for expelling the extinguishing agent is achieved. According to this method, it is however difficult to ensure that only the Halon is expelled during the three phases if the igniter is a gas generator that is coupled to the container to have a generated pressure act upon the fire extinguishing agent to expel the fire extinguishing agent over an expel-exit of the container. The same problem can arise in case of a use with Novec, wherein an expelling of the Novec cannot be entirely ensured due to a possible additional expelling of gas from the gas generator out of the container, before the whole Novec has been expelled.

### SUMMARY OF THE INVENTION

It is therefore one aim of the invention to provide an apparatus and a method for extinguishing a fire comprising a container with an extinguishing agent and a pressure generator for expelling the agent out of the container so-that the expelling of the agent is improved.

A fire extinguishing apparatus is hence proposed, comprising:
a container configured to receive and retain a fire extinguishing agent;
a pressure generator coupled to the container to have a generated pressure act upon the fire extinguishing agent to expel the fire extinguishing agent over an expel-exit of the container.

Due to a separator which is placed within the container so that the fire extinguishing agent and the pressure generator (and hence its produced gas) are separated, it is advantageously possible to provide a pressure effect on the extinguishing agent without any risks of mixing a pressurized gas from the pressure generator and the extinguishing agent, especially by the ignition phase of the pressure generator, wherein only the extinguishing agent has to be expelled out of the container.

The used separator can be a membrane (or a plunger) with different properties (material resistance for heat or mechanically strains , elasticity, placing manner in the container, fixation means, open-able part, hardened part, tearing characteristics) that allowed an effective expelling of the extinguishing agent as well as a further profitable use of a hot gas from pressure generator for a bleeding of a pipe that is coupled to expel-exit of the container.

By using a separator like a closed membrane with an aperture that is gas tightly coupled to an gas outlet of the pressure generator, the container can be manufactured in only one main piece (sphere or cylinder) with a seal based connection for inserting and fixing both separator and gas generator.

According to this concept that is making use of a separator, four examples of apparatus for extinguishing a fire according to the present invention and their respective advantages will be described in the following text.

Furthermore a method for expelling an extinguishing agent that is contained in a container of a fire extinguishing apparatus is described, wherein a pressure generator coupled to the container generates a pressure act upon the fire extinguishing agent to expel the fire extinguishing agent over an expel-exit of the container. The method used advantageously a separator 36 that comprises at least a membrane which is gas tightly (eventually indirectly) coupled to the pressure generator, wherein:
by inactivated pressure generator the whole membrane is in a position closed to a first inner surface of the container in area of the pressure generator,
during its activation the pressure generator delivers a gas in the membrane so that at least a part of the whole membrane is spreading in direction to a second inner part of the container comprising the expel-exit of container.

At the end of said spreading a mean to interpenetrate the membrane provides a further expelling of the gas through the expel-exit of the container.

By this way, a strong improvement is achieved, since the gas produced by pressure generator cannot be expelled within the expelling phase of the extinguishing agent (Novec but also Halon or other agents). Only after the expelling of the entire extinguishing agent, the gas is outputted of the container for example over the finally bursted membrane. During the expelling of the entire extinguishing agent, the gas from the pressure generator and the extinguishing agent are contact-less and the gas from pressure generator cannot be discharged over the expel-exit of container.

Since the spreading of the membrane can be dynamically precisely controlled, the expelling of the agent is also improved. Moreover, at end of said spreading a pipe that is coupled to the expel-exit of container can be bleeded by perforating the membrane such that a hot gas (initially from pressure generator) is injected in the pipe.

### BRIEF DESCRIPTION OF THE SEVERAL VIEWS OF THE DRAWINGS

These and other aspects, advantages and novel features of the embodiments described herein will become apparent upon reading the following detailed description and upon reference to the accompanying drawings. In the drawings, same elements have the same reference numerals.

FIG. 1 shows a first schematic illustration of one apparatus of a fire extinguishing apparatus with a membrane that is fixed to the container;

FIG. 2 illustrates a second exemplary apparatus of the fire extinguishing apparatus with a membrane gas tightly coupled to pressure generator;

FIG. 3 gives a third exemplary apparatus of the fire extinguishing apparatus with a membrane gas tightly coupled to pressure generator according to FIG. 2;

FIG. 4 shows a fourth exemplary apparatus of the fire extinguishing apparatus with a cylindrical container;

FIGS. 5A, 5B and 5C illustrate the deployment of the separator by activation of the pressure gas generator for use in a fire extinguishing apparatus.

### DETAILED DESCRIPTION OF THE SEVERAL VIEWS OF THE DRAWINGS

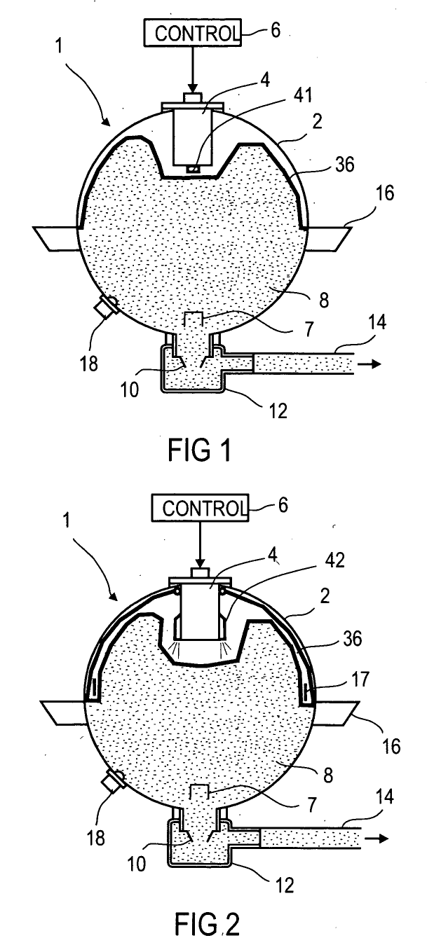

FIG. 1 shows a schematic illustration of one embodiment of a fire extinguishing apparatus 1 mounted to a structure 16. In one application, the fire extinguishing apparatus 1 may be installed in an automobile, train, aircraft or ship, for example, next to or within an engine or cargo compartment, to extinguish or suppress a fire. It is contemplated that the fire extinguishing apparatus 1 may be installed at any location where the risk of fire exists and rapid fire extinguishing is required, such as at an industrial site, a power generation or transformer station, a data processing or storage room, or an aircraft engine, in particular a jet engine.

For ease of reference, the term “extinguishing” is used hereinafter to refer to both extinguishing and suppressing a fire. Those of ordinary skill in the art will appreciate that the initial objective in fighting a fire is to extinguish (“knock-down”) a fire and, then, to suppress the re-start of the fire. Further, the term “fire” is used hereinafter to refer to any phenomenon of combustion manifested in light, flame, gas, smoke or heat, including a destructive burning of material.

The fire extinguishing apparatus 1 may be triggered manually or automatically. In either case, a sensor mounted at a location that is at risk of fire may detect a fire by determining, for example, an increased temperature or a change in the characteristics of air due to the presence of smoke or gas. Once the sensor detects a fire, the sensor generates a signal that may trigger a warning display, for example, in the cockpit of a vehicle. The operator of the vehicle then decides whether or not to manually activate the fire extinguishing apparatus 1. In the alternative, the signal generated by the sensor may automatically trigger the activation of the fire extinguishing apparatus 1.

As shown in FIG. 1, the fire extinguishing apparatus 1 includes a container 2 and a closure 10 like a rupture disc (in FIG. 1, the closure 10 is already represented in “ruptured” state, that means open) configured to receive and retain a fire extinguishing agent 8. In one embodiment, the fire extinguishing agent 8 is a liquid (it could be a gas) selected to have fire extinguishing capabilities, as described below. The closure 10 seals the container 2 and is located within a discharge head 12 that connects a discharge pipe 14 to the container 2. The discharge pipe 14 is configured to direct the fire extinguishing agent 8 to the location of a fire.

In one embodiment, the closure 10 may include a disc or a membrane that rupture at a predetermined pressure. In another embodiment, the closure 10 may include a valve that opens at a predetermined pressure. In these embodiments, no active devices such as a rupturing detonator are required. Further, the closure 10 may have score lines and hinge areas to open in a petal like fashion to prevent the generation of mechanical debris.

In another embodiment, the closure 10 may include a controllable valve. A control device causes the valve to open, and controls the flow of extinguishing agent 8 through the valve.

In the illustrated embodiment, the container 2 has a spherical shape with a diameter between about 20 cm and about 60 cm. However, it is contemplated that the container 2 may have any other shape suitable for the application, for example, an oval, a cylindrical shape or any suitable combination of these shapes to satisfy the needs of a specific application or location. The container 2 is made of stainless steel, aluminum alloys or a composite material having strength sufficient to withstand predetermined pressure differences between an interior and an ambient atmosphere. In one embodiment, the container 2 is made of stainless steel and has a wall thickness of between about 1 mm and about 2 mm. In another embodiment, the container 2 may be made of a composite material and a metallic liner at an interior wall of the container 2 having properties as to temperature and pressure that are comparable to a steel container.

The fire extinguishing apparatus 1 includes further a gas based pressure generator 4. In the embodiment shown in FIG. 1, the gas generator 4 extends into the container 2 and is coupled to a control device 6 that activates the gas generator 4. The gas generator 4 has a housing and includes a fuel material that, when ignited, generates a high-temperature gas that acts as a propellant. The high-temperature gas causes a pressure within the container 2 of about 10 to 60 bars. The pressure within the container 2 provides the required energy to expel the fire extinguishing agent 8 from the fire extinguishing apparatus 1 towards the location of the fire.

FIG. 1 shows the fire extinguishing apparatus 1 in the active state, in which the increasing pressure within the container 2 already caused the closure 10 to rupture and some of the fire extinguishing agent 8 to be expelled from the container 2.

The fire extinguishing apparatus 1 of FIG. 1 includes a separator 36 configured to separate the extinguishing agent 8 from the gas generated by the gas generator 4. In the following text, the term “gas or pressure generator” will be used. A use of pyrotechnical or other gas/pressure based generators is also possible, but, for a better clarity, the scope of the invention does not require to be extended in that way. The separator 36 may be a heat resistant foil or liner secured to the interior surface of the container 2. In addition to being heat resistant, the separator 36 may have flexible or elastic properties, or a combination of these properties. Using for example an extensible separator can be easier in terms of manufacturing the separator because of the possibility of extensibility by de-moulding the separator. For example, the foil or liner may be secured along the largest circumference of the container 2 so that it prevents gas from interacting with the extinguishing agent 8 or contaminating the extinguishing agent 8. In one embodiment, the separator 36 is made of Kevlar® or Nomex® available from Dupont.

In FIG. 1, the separator 36 is movable from an gas output 41 of the pressure generator 4 to the expel-exit (near closure 10) of the container 2. At end of said spreading of the membrane (by arriving in the area of expel-exit of the container 2), a mean 7 to interpenetrate the membrane may be used there to provide a further expelling of the gas through the expel-exit of the container 2. It can be a cutter for piercing the membrane or an impact element to open a valve of the membrane. By this way, the membrane can tear and deliver the hot gas of pressure generator 4 in the pipe 14. The pipe 14 can be hence easily bleeded.

In FIG. 2, the second apparatus presents principally the same features as the apparatus of FIG. 1, except that only a part of the separator 36 is movable from the gas outlet 41 of the pressure generator 4 to the expel-exit (near the closure 10) of the container 2 and that the separator is a closed membrane comprising an inlet that is gas tightly coupled to the pressure generator 4. In simple words, the separator 36 acts as a inflatable (optionally extensible) ball in the container 2 which is pumped by the gas generator 4.

The membrane can be interpreted as an upper side and an down side that describe a the whole ball. By inactivated pressure generator 4, the down side of the membrane 36 comprising the outlet of pressure generator 4 is folded in the inner part of the upper side so that both sides covers the upper inner part of the container 2 comprising the gas generator 4. That means that the extinguishing agent is located in the whole container 2 under the down side of the membrane 36.

When the pressure generator 4 is ignited, a hot gas is outputted in the closed membrane 36 such that its inflating begins. The down part of the membrane is hence moving to the expel-exit of the container 2, since the upper part of the membrane stays at the inner part of the container 2 comprising the gas generator 4. FIG. 2 represents this state, wherein the closure 10 is broken because of the increasing pressure in the container 2.

At least a part of a section of the membrane in front of its inlet (base of the gas generator) on the container 2) is hardened in order to facilitate the deployment or unfolding of the down part of the membrane 36. This hardening can be realized by means of a ring 17 which is represented in section in FIG. 2. This ring has to resist also by heating conditions. It can be also flexible, so that it may be introduced into the container 2 with the gas generator 4 and the membrane 36 that are also therein insert-able. Other substitute hardening means may be used, for example a membrane in a material with different hardening factors at least at the location of the previous ring or a membrane with a high hardening factor at its upper part and a low hardening factor at its down part, so that the same effect is provided for helping the unfolding of at least the down part of the membrane 36.

In FIG. 2, the gas generator 4 produces gas over deflecting means 42 that are oriented over at least a part of the separator 36 such that an homogeneous spreading of this part to an inner part of the container 2 comprising the expel-exit of the container 2 is provided. If the gas generator produces an hot gas over the membrane 36, the deflecting means 42 are oriented such that heat-damages on the separator 36 can be also avoided.

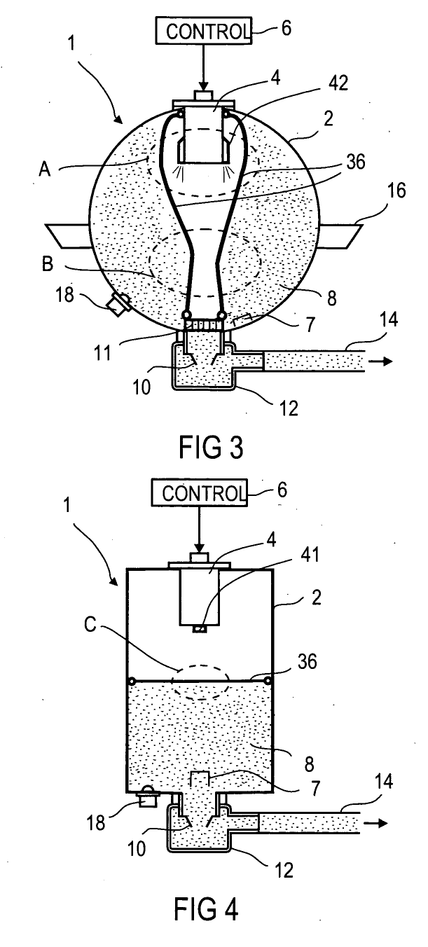

In FIG. 3, the represented apparatus shows a separator 36 that is a closed membrane comprising an inlet that is gas tightly coupled to the pressure generator 4 and a fixation point 11 (or through inflating, a meeting contact point between membrane and expel-exit of container 2) closed to upper side of the expel-exit of container 2 so that lateral sides of the expel-exit are also uncovered. By this way, the extinguishing agent 8 can be expelled over the lateral sides as the membrane is inflating. As in FIG. 2, some hardening means (for example by mean of a variable thick along the membrane) can be also used so that an upper part A of the membrane that is closed to the gas generator 4 inflates faster than a down part B of the membrane. Hence the extinguishing agent is progressively moved from the corresponding upper inner part of the container 2 to the down part of the container 2. Some remaining “bubbles” of extinguishing agent 8, in particular between the upper part A of the membrane 36 and the neighbored inner part of the container 2, are also advantageously avoided. In resume, the membrane may provide an increasing hardening factor from the area of its gas inlet to its fixation point 11 in range of the expel-exit at the inner surface of the container 2 (or meeting point with the expel-exit of the container 2).

In comparison to FIG. 1, the apparatus of FIGS. 2 and 3 may use of such hardening means for the membrane in order to allow a well-controlled deployment (unfolding) of movables parts of a membrane according to their moving dynamics and destinations. By this way, a further control on the expelling dynamics of the extinguishing agent 8 can be provided.

In FIG. 1, the separator 36 is a membrane that has been simply fixed to the equator section of inner surface of the spherical container 2. Optionally a hardening gradient may be also used from this ring based fixation to the expel-exit of the container 2.

As well as in FIG. 1, the separator 36 of FIGS. 2 and 3 may comprise an extensible membrane. From a point of view of manufacturing the membrane, it is advantageously as described above, but this allows also a comfortable insertion of the membrane (tightly fixed with the gas generator) in the aperture of the container 2.

In FIG. 4, a third apparatus for extinguishing a fire is represented, wherein the container 2 is a cylinder and the separator 36 is a plunger that is configured to slide therein. The plunger isolates tightly the area of gas inlet from the gas generator 4 and the extinguishing agent 8. Instead of a plunger a membrane like in FIG. 1 may be used so that it will be fixed to the inner part of the container 2 or like the other FIGS. 2 and 3. It is however obvious to understand that, since the membrane should be cylindrical or extensible to fit to the inner parts of the container 2, the membrane is not the best choice.

In all FIGS. 1 to 4, the separator 36 (membrane, plunger) comprises a closed outlet part that is open-able by a mean 7 placed in the range of the expel-exit of the container 2. In FIG. 4, the closed outlet of the plunger can be realized by mean of a breakable part C of the plunger that is colliding with said breaking mean 7 at end phase of the expelling of extinguishing agent 8. The same principle can be used for other apparatus according to FIGS. 1 to 3, wherein a part of the separator 36 (membrane) under pressure from pressure generator 4 fits to an inner part of the container 2 comprising the expel-exit of the container 2. The mean 7 is placed In this range so that under pressure with this part of membrane it interpenetrates the membrane. For making this interpenetration easier, it is possible to decrease the material resistance of the membrane at this location. After breaking/interpenetrating the plunger/membrane (membrane can also tear), the gas contained in the membrane is also expelling out of the container 2, for example over the pipe leading to the fire. By this way, the pipe can be bleeded.

Assuming that the pressure generator of the present invention uses a gas generator that delivers a hot gas, the separator 36 has to be made of a heat resistant material.

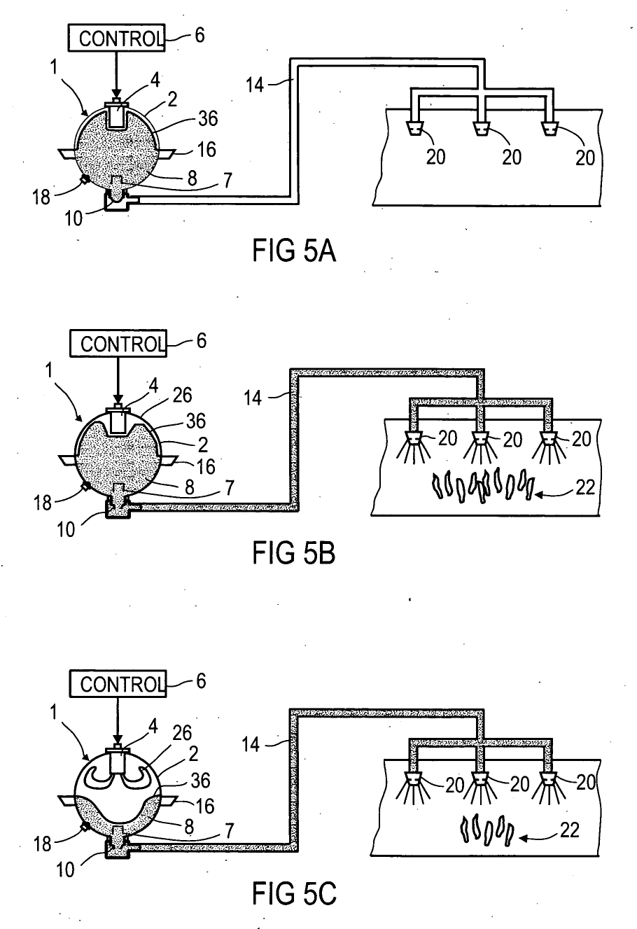

FIGS. 5A, 5B and 5C illustrate a method for extinguishing a fire according to the fire extinguishing apparatus 1 of FIG. 1. Principally, this method is the same for all other apparatus of the present invention. Similar to FIGS. 2A, 2B, the discharge pipe 14 is connected to outlets 20 located in proximity of a location that is at risk of a fire 22. In FIG. 5A, the fire extinguishing apparatus 1 is in the stand-by state in which the gas generator 4 is inactive and the container 2 is filled with the fire extinguishing agent 8. The extinguishing agent 8 urges the separator 36 against the interior surface of the container 2.

In FIG. 5B, the control device 6 activates the gas generator 4 due to the detected fire 22. Generated gas 26 increases the pressure within the container 2 forcing the separator 36 away from the interior surface of the container 2. As shown in FIG. 5B, the separator 36 initially leaves the surface in proximity of the gas generator 4. The increased pressure within the container 2 causes the closure 10 to rupture and the outlets 20 to discharge the extinguishing agent 8 in the pipe 14. The discharged extinguishing agent 8 rains upon the fire 22, for example, as a mist.

At this state, a spreading of the membrane like in FIG. 2 could hence consists in unfolding of at least a part of the membrane from first part to second inner part of container 2, wherein the other part of the membrane is maintained coupled to the gas generator 4.

FIG. 5C illustrates the last state of the extinguishing process. The gas generator 4 still generates the gas 26 that presses against the separator 36. During this last state, the gas 26 urges the separator 36 towards the interior surface of the container 2, which is opposite to the surface during the stand-by state. In this state, the remaining extinguishing agent 8 is expelled from the container 2.

When the membrane reaches the interpenetrating mean 7 (cutter for piercing the membrane or an impact element to open a valve of the membrane), it can tear and the gas is also expelled in the pipe 14, for example for its bleeding.

It is apparent that there has been disclosed several apparatus and a method for extinguishing a fire that fully satisfies the objects, means, and advantages set forth hereinbefore. While specific embodiments of the apparatus and method have been described, it is evident that many alternatives, modifications, and variations will be apparent to those skilled in the art in light of the foregoing description.

1. A fire extinguishing apparatus, comprising:
a container configured to receive and retain a fire extinguishing agent;
a pressure generator coupled to the container to have a generated pressure act upon the fire extinguishing agent to expel the fire extinguishing agent over an expel-exit of the container;
a separator is placed within the container so that the fire extinguishing agent and the pressure generator are separated.

2. The apparatus according to claim 1, wherein a part of the separator is movable from an output of the pressure generator to the expel-exit of the container.

3. The apparatus according to claim 1, wherein the separator is a closed membrane comprising an inlet that is gas tightly coupled to the pressure generator.

4. The apparatus according to claim 2, wherein the separator is a closed membrane comprising an inlet that is gas tightly coupled to the pressure generator.

5. The apparatus according to claim 1, wherein at least a part of a section of the membrane in front of its inlet is hardened.

6. The apparatus according to claim 5, wherein said hardening is provided by means of a ring.

7. The apparatus according to claim 3, wherein the container is one piece with an aperture in which the separator is insert-able in the container and over which the pressure generator is hermetically coupled with the container.

8. The apparatus according to claim 4, wherein the container is one piece with an aperture in which the separator is insert-able in the container and over which the pressure generator is hermetically coupled with the container.

9. The apparatus according to claim 1, wherein the separator is a closed membrane comprising an inlet that is gas tightly coupled to the pressure generator and a fixation point closed to upper side of the expel-exit of container so that lateral sides of the expel-exit are uncovered.

10. The apparatus according to claim 9, wherein the membrane provides an increasing hardening factor from its inlet to its fixation point.

11. The apparatus according to claim 1, wherein the separator is a membrane that has been fixed to the inner surface of the container.

12. The apparatus according to claim 1, wherein the separator comprises an extensible membrane.

13. The apparatus according to claim 1, wherein the container is a cylinder and the separator is a plunger that is configured to slide therein.

14. The apparatus according to claim 1, wherein the separator comprises a closed outlet part that is open-able by a mean placed in the range of the expel-exit of the container.

15. The apparatus according to claim 1, wherein under pressure from pressure generator a part of the separator fits to an inner part of the container comprising the expel-exit of the container.

16. The apparatus according to claim 1, wherein the separator is made of a heat resistant material.

17. The apparatus according to claim 1, wherein the pressure generator is a gas generator or a pyrotechnical generator.

18. The apparatus according to claim 17, wherein the gas generator produces gas over deflecting means that are oriented over at least a part of the separator such that a homogeneous spreading of this part to an inner part of the container comprising the expel-exit of the container is provided.

19. The apparatus according to claim 17, wherein the gas generator produces hot gas over deflecting means that are oriented such that heat-damages on the separator are avoided.

20. A method for expelling an extinguishing agent that is contained in a container of a fire extinguishing apparatus, wherein a pressure generator coupled to the container generates a pressure act upon the fire extinguishing agent to expel the fire extinguishing agent over an expel-exit of the container, the method using:
a separator that comprises at least a membrane which is gas tightly coupled to the pressure generator, wherein:
by inactivated pressure generator the whole membrane is in a position closed to a first inner surface of the container in area of the pressure generator,
during its activation the pressure generator delivers a gas in the membrane so that at least a part of the whole membrane is spreading in direction to a second inner part of the container comprising the expel-exit of container.

21. The method according to claim 20, wherein at end of said spreading a mean to interpenetrate the membrane provides an expelling of the gas through the expel-exit of the container.

22. The method according to claim 20, wherein said spreading consists in unfolding of at least a part of the membrane from first part to second inner part of container.

23. The method according to claim 20, wherein the other part of the membrane is maintained coupled to the gas generator.

24. The method according to claim 21, wherein the mean to interpenetrate the membrane is a cutter for piercing the membrane or an impact element to open a valve of the membrane.

25. The method according to claim 21, wherein by said interpenetrating the membrane tears.

26. The method according to claim 21, wherein after said interpenetrating of membrane, the gas is expelled from the container and has necessary properties to bleed a pipe that is coupled to expel-exit of the container.

27. The method according to claim 20, wherein a rupture-able closure element is used at the expel-exit of the container to close the container and filter means are used to avoid an expelling of fragments of the rupture element in a pipe that is coupled to expel-exit of the container.

28. The method according to claim 20, wherein as extinguishing agent Halon or Novec is used.
